(19) United States
(12) Patent Application Publication
(10) Pub. No.: US 2005/0247268 A1
(43) Pub. Date: Nov. 10, 2005

(54) Fish restraining apparatus

(76) Inventor: Kenneth U. Lau, Pendleton, IN (US)

Correspondence Address: Kenneth U. Lau, 201 N. Main St., Pendleton, IN, 46064, US

(21) Appl. No.: 10/841,191

(22) Filed: May 10, 2004

(51) Int. Cl. A01K 63/00

(52) U.S. Cl. 119/215

(57) ABSTRACT

The apparatus holds the fish or other body in place. The apparatus has a swing trap door at each end. The trap door can help guide the fish to enter one end of the apparatus and exit the other end of the apparatus. The apparatus also has multiple ports at all four other sides allowing access to the fish or body for treatment. Inside the cavity there is a sliding side plate which will help to maintain the fish or body in place. When the treatment is completed, the fish or body can be released. Additional features and advantages of the fish restraining device will become apparent to those skilled in the art upon consideration of the following detailed descriptions exemplifying the best mode of carrying out the fish restraining device as presently perceived.

### BACKGROUND OF THE INVENTION

Due to the increasing popularity of the Koi fish, there has been a marked increase in the collection of these fish by the general population for backyard ponds. With this increased popularity comes the need for a system which will allow the layman to restrain the fish during the administration of medicine. For the most effective application of medication the fish needs to be restrained. Most layman or general hobbyist do not know how to do this. This restraining apparatus does this for them.

### SUMMARY OF THE INVENTION

The apparatus holds the fish or other body and has ports allowing access to the fish or body for treatment of same. The apparatus comprises a bias directed toward the fish or body inside the cavity to maintain the fish or body in place. When the treatment is completed, the fish or body can be released.

Additional features and advantages of the fish restraining device will become apparent to those skilled in the art upon consideration of the following detailed descriptions exemplifying the best mode of carrying out the fish restraining device as presently perceived.

This apparatus is intended for use by the hobbyist.

### DISCLOSURE OF THE ILLUSTRATIVE EMBODIMENT

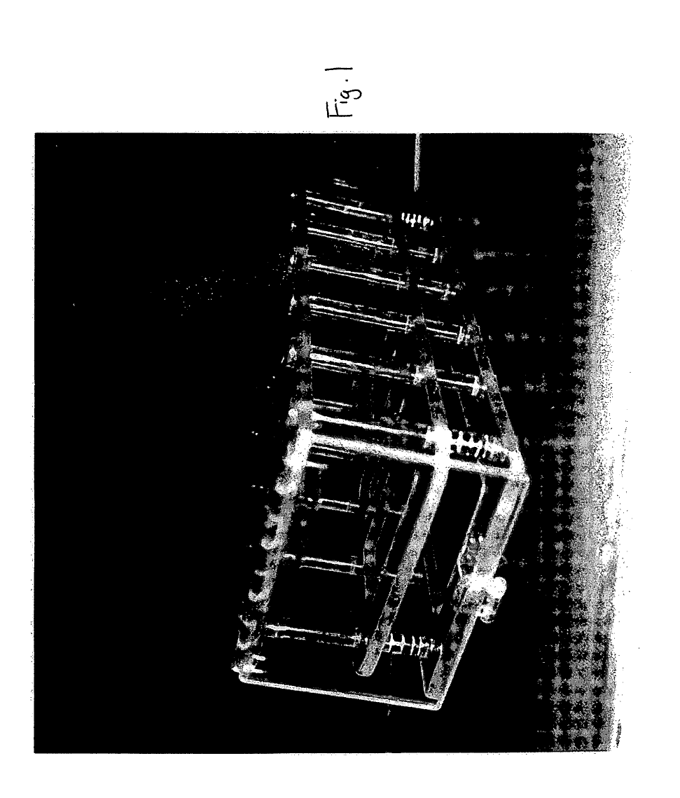

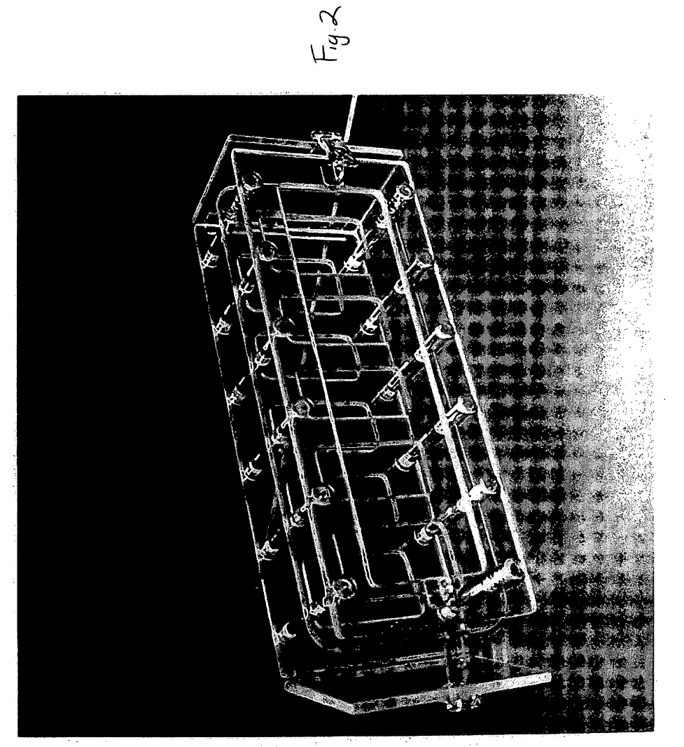

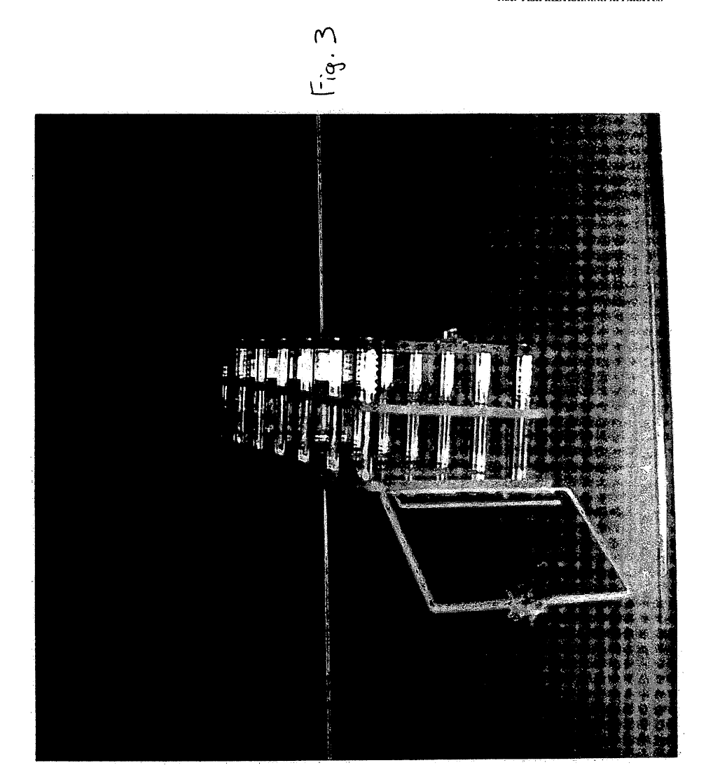

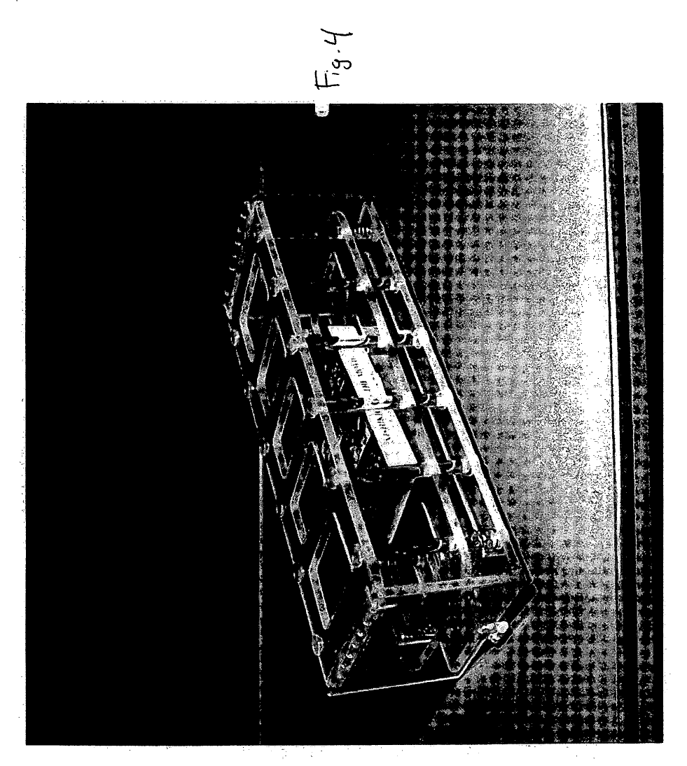

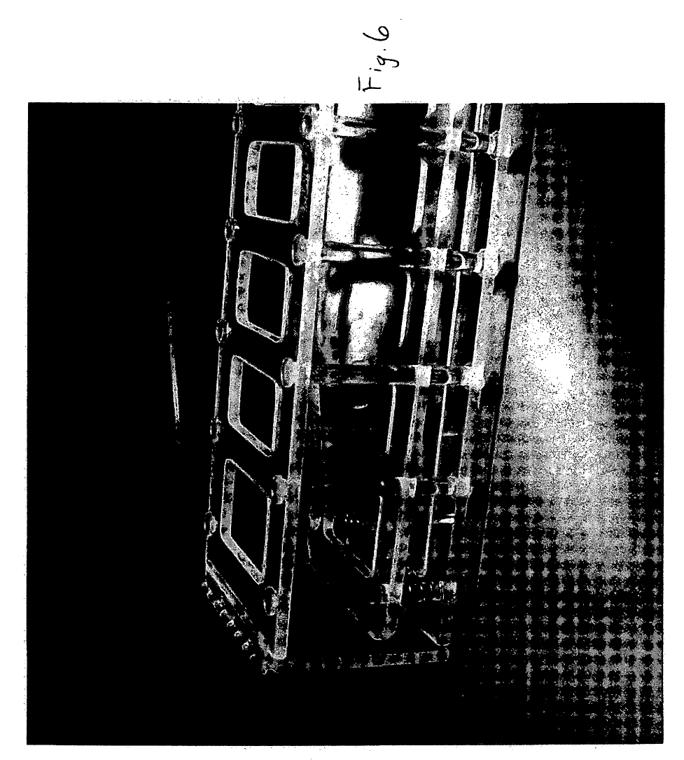

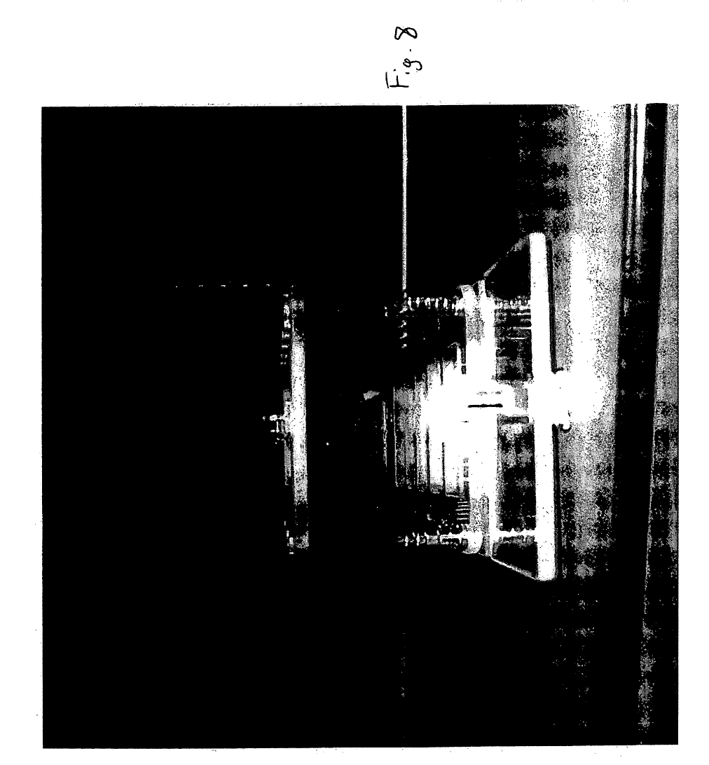

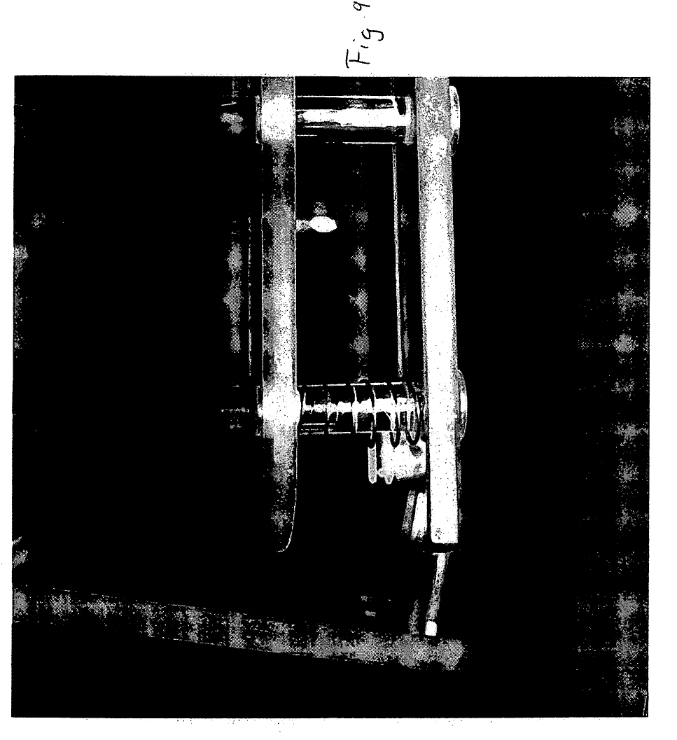

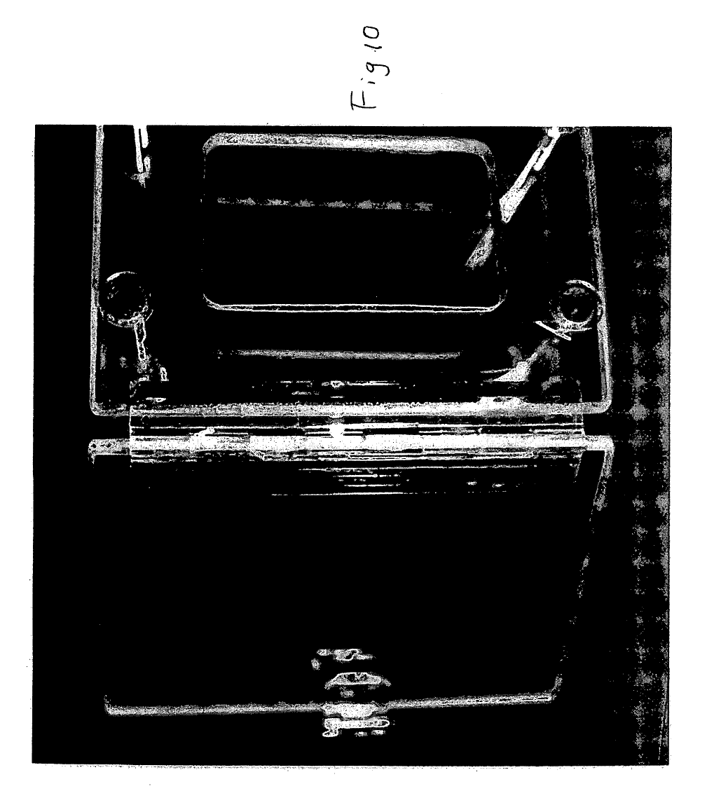

In this illustrative embodiment, as shown if FIGS. 1 through 11, the apparatus comprises a first end member, and a second end member. The apparatus also comprises an intermediate member located therebetween. As shown in FIG. 1, the end members are illustratively separated by spacers forming a cavity therebetween wherein the intermediate member is located. In the illustrative embodiment, the intermediate member is biased toward one of the end members. Illustratively, the bias can be in the form of springs. In the illustrated embodiment, the bias means are springs that form about the spacers and are located between one of the end members and the intermediate member. The bias will oppose the fish or other body that is located between the intermediate and one of the end members. (See, for example, FIGS. 4 and 6.) This produces a snug fit to the fish or body located in the apparatus. Such a fit prevents the body from moving substantially, keeping it relatively still during treatment.

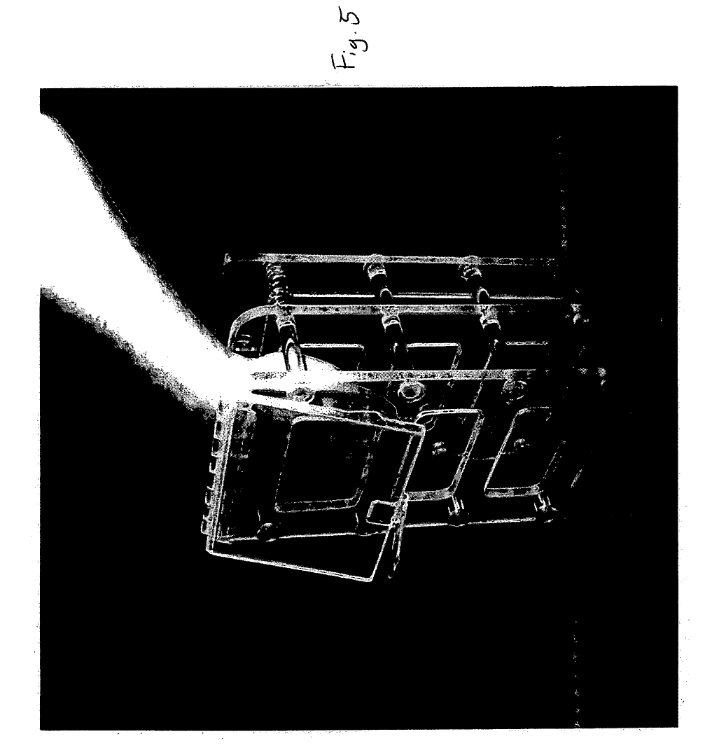

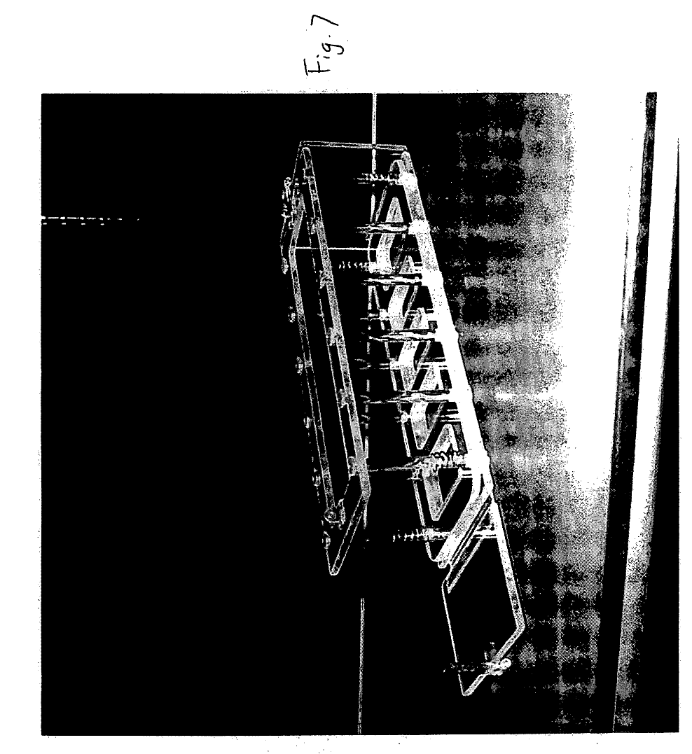

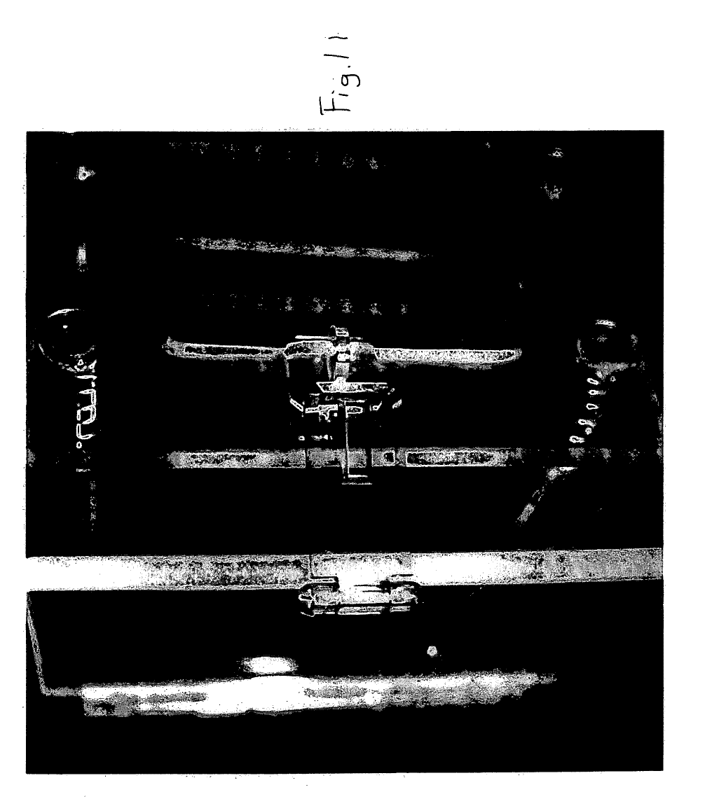

Shown in FIGS. 1 through 3, openings are illustratively formed at opposed sides of the apparatus. Illustratively, a door, like the hinged door shown in detail in FIGS. 7, 10, and 11, are located on the sides of the apparatus. This configuration allows the fish to be selectively inserted on one side, for example, and expelled from the other side. (See FIG. 5.) The door can be latched, such as that shown in FIG. 11. Also shown in all of the figures are access ports in the apparatus. In the illustrative embodiment, ports are available in both the first and second end members as well as the intermediate member. These ports allow access to the fish or the body for treatment. In addition, as the figures show, the apparatus can be rotated, yet, access to the body, almost anywhere, is still available.

Corresponding reference characters indicate corresponding parts throughout the several views. Although the present disclosure has been described with reference to particular means, materials and embodiments, from the foregoing description, one skilled in the art can easily ascertain the essential characteristics of the invention and various changes and modifications may be made to adapt the various uses and characteristics without departing from the spirit and scope of the invention.

1. This apparatus will be used for individual hobbyists. Currently, there is no such thing available.

2. That the invention will restrain the fish in a neutral position accessible from all sides, top and bottom.

3. That the invention can be submerged under water, thus keeping the fish alive.

4. That fish can be guided into this invention from either trap door at either end.

5. Fish can enter the invention from one end and exit from the other end.

6. This invention does not use a head mold to restrict the fish.

7. This invention has a moveable side wall which is operated by hand and not by step motors.

8. This invention is small and portable and comes in three sizes:

| | |
|---|---|
| Small | 11 × 4 × 4.5 |
| Medium | 14 × 5 × 5 |
| Large | 18 × 7.5 × 5 |
